(19) United States
(12) Patent Application Publication
(10) Pub. No.: US 2011/0149692 A1
(43) Pub. Date: Jun. 23, 2011

(54) Method of Communication Using Improved Multi-Frequency Hydraulic Oscillator

(76) Inventor: Herman D. Collette, Houston, TX (US)

(21) Appl. No.: 13/057,047

(22) PCT Filed: Aug. 24, 2009
(86) PCT No.: PCT/US09/04814

§ 371 Date: Mar. 7, 2011

Related U.S. Application Data
(60) Provisional application No. 61/091,364, filed on Aug. 23, 2008.

(51) Int. Cl. G01V 1/145

(52) U.S. Cl. 367/143

(57) ABSTRACT

In a measuring while drilling or similar system, a pressure balance drive cylinder exhaust valve is driven by a toggling sense piston. Reset of the sense piston creates a pressure balance across the exhaust valve such that, as the pressure within the drive cylinder regeneratively increases, this pressure is applied to both sides of the exhaust valve. The pressure balance thus created greatly reduces the force necessary to close the exhaust valve. Once the sense piston is driven past the toggle allowing the drive cylinder pressure to have an offset pressure equal to the downstream main valve pressure, the drive cylinder forces the exhaust valve open thus decreasing the drive cylinder pressure. The pressure reduction allows the sense piston to reset, thereby restarting the process. Because the main poppet is driven by the drive cylinder pressure, the cyclic set and reset of the sense piston results in drive cylinder pressures that alternatively insert and remove the poppet from the orifice causing pressure oscillations within the conduit. The frequency of this oscillation is controlled either by the rate that fluid is allowed to enter the drive cylinder or by a sear used to interrupt operation of the sense piston.

### FIELD OF THE INVENTION

The present invention relates generally to the field of data communication and, more particularly, to a data communication system that improves near-subsonic asynchronous transmissions of data between stations within a hydraulic conduit. Systems employing these types of transmissions are prevalent in earth bore drilling where they are used to convey encoded and encrypted position and environment information from near the point of penetration to the earth's surface. Even more particularly, the system and method described herein may also be used to convey encoded control signals from the earth surface to a bottom hole assembly of a drilling apparatus. The system and method create repeated, cyclic pressure oscillations for the transmission of these data within such a conduit primarily using energy from the circulating fluid and a small control signal.

### BACKGROUND OF THE INVENTION

Remotely operated sensor packages have been used during the drilling of wells for a number of years. Similar systems are used in sewer line cleaning systems. The sensor packages commonly found in these applications provide information such as the inclination, azimuth, and various logging sensor measurements that are of interest.

During typical well drilling operations, a hydraulic fluid, known in the art as ‘drilling mud’ or ‘drilling fluid’, is pumped through the drill pipe into a bottom hole assembly which may contain mechanical devices to control the direction of the drill bit in forming the borehole. The bottom hole assembly may also contain hydraulic motors and/or hammers to provide power to the drill bit. This fluid is also circulated through the drill bit to clean, lubricate, and cool the bit. The drilling fluid carrying cuttings then returns to the surface by way of the annulus between the drill pipe and the bore hole or casing, where the drilling fluid is cleaned of cuttings so that the drilling fluid can be re-used. Other systems such as sewer cleaning systems generally employ an open ended system where fluid is pumped down a conduit and exits a bit or cleaning head and drains through the system.

In the case of drilling wells, it was established as early as 1942, that the flowing drilling fluid could be used as a transmission medium for data developed down hole during drilling operations, thus the origin of the term “measuring while drilling” (MWD). Early systems employed two signal methods. In a “Positive Pulse” system, as shown for example in Arps U.S. Pat. Nos. 2,677,790 and 2,759,143; a device varies the pressure of the drilling fluid in the drill pipe by placing an orifice in the drill string and inserting a poppet into the orifice to increase the pressure within the drill pipe. In a “Negative Pulse” system, such as for example in Arps and Sherbatskoy U.S. Pat. No. 2,755,432 and Gearhart and Sherbatskoy, et. al. U.S. Pat. No. 3,964,556 and Sherbatskoy, U.S. Pat. No. 4,351,037; an orifice is opened between the drill pipe and the annulus allowing the flow to bypass the bottom remainder of the bottom hole assembly and the drill bit. This orifice is closed by a poppet sealing off the flow to the annulus. The momentary opening creates a ‘short circuit’ and reduces the pressure within the drill pipe, resulting in a negative pressure pulse.

By repeated insertion and removal of the poppet, thereby opening and shutting the orifice, a series of pressure pulses is created in the drilling fluid. These pressure pulses or variations may be detected at the surface and used to convey information. Unfortunately, these pressure variations are very low frequency, referred to within the industry as a ‘pulse’, and amount to pressure level changes wherein the spectral components of the transmitted signal centered at approximately 3 Hz, and transmitted energy occurs below 20 Hz with a peak energy centered in the range of 0.1 to 1.5 Hz. Sherbatskoy recognized that the system imposed an upper frequency limit of approximately 100 Hz, where regardless of initial spectral component of the original pulse no frequency component of the original pressure level shift above this frequency could be detected.

In addition to severely limiting the data transmission rate, these low frequencies created by mud pulsers coincide with the noise frequencies generated during drilling. In data communication in general, one common technique for improving the signal to noise ratio is to filter the noise. As a consequence of the similarities of signal and noise frequencies, conventional filtering, used to eliminate drilling noise, also removes much of the remaining energy from the transmitted pulse. In an effort to improve performance of positive pulse systems, the amplitude of the induced pressure pulses was increased. However, erosion of the valve components by the pressure pulses is a function of the imposed pressure drop. Thus, increasing the pressure drop decreased pulser life. Another problem with simply increasing the amplitude of the induced pressure pulses was the power required to create such pulses. The large power demand meant a large and more powerful prime mover to operate the poppet, and this contributed to greater weight and cost for the MWD system.

Godbey, in U.S. Pat. No. 3,309,656; recognized the ability of the fluid system to support a continuous low frequency cyclic transmission. Godbey's challenge was to investigate downhole equipment condition and use of multiple frequencies to indicate that condition. This was done by observing and recording which frequency was transmitted. The frequencies produced conveyed status without data encryption. Unlike the ‘valve pulsers’ described herein, Godbey employed an axially rotatable pressure element. This method was improved by Patton, as shown and described in U.S. Pat. No. 3,789,355; wherein encryption was employed in synchronous transmission. Claycomb, U.S. Pat. No. 3,997,867; and others form the basis of current commercial synchronous transmitters. These synchronous systems improve signal to noise ratio and consequently data rate.

The basis of this improvement in data rate can be found in signal theory. Within any medium where differences propagate, information can be transmitted and is subject to a detectability limit that is dependent on acceptable error rate. This limit is known as the channel capacity. The channel capacity is dependent on the signal to noise ratio within the frequency band of the propagation at the receiver and is described by Hartley's law. Although Hartley's law was originally applied to transmission of ‘pulses’ within a communication channel, it is nonetheless applicable to transmissions of state change whether this state is a frequency, an amplitude (as implied by pulses) or phase.

Hartley's law argues that the maximum number of distinct pieces of information that can be transmitted and received reliably over any communication channel is limited by the dynamic range of the measured state change. For example, if we consider the change of pressure accompanying a constant frequency sound that propagates from a source, and if the amplitude of this sound is limited to some value between P(1) and P(2) out of a detectable pressure range of P(a) to P(b), then the maximum number of distinct units of information is:

$$M = 1 + \frac{A}{Δ P} = 1 + \frac{\vert P ( 2 ) - P ( 1 ) \vert}{\vert P ( b ) - P ( a ) \vert}$$

If this pressure difference represents a binary information stream the information per transition in bits is 2^{M}. Hartley stated this measure of information rate R as:

R=fₜ log₂(M)

Where fₜ is the transition rate or baud.

Based on fundamental energy considerations including all possible multi-level and multi-phase encoding schemes, Shannon (The Bell System Technical Journal, Vol. 27, pp. 379-423, 623-656, July, October 1948) derived the relation between a theoretical upper baud rate of a signal of strength S and the level of additive white noise N.

$$C = B {log}_{2} ( 1 + \frac{S}{N} )$$

### Where:

C is the channel capacity of a noisy channel in bits per second

B is the bandwidth of the channel in Hz (cycles-per-second)

S is the signal power (usually measured in Watts but in our instance measured in

Q^{•}ΔP

Where: Q^{•} is the mass flow rate
ΔP is the pressure change

N is the total noise power over the bandwidth measured in comparable units. S/N is the signal-to-noise ratio. In practical fluid pulse transmission this is in-band pressure fluctuation or flowing pressure while in fluid oscillator transmission this is signal-to-noise ratio for only the affected frequency.

Energy spectral density describes how the energy of a signal is distributed with frequency. Assuming that both an oscillatory signal and the channel noise signal is continuous over a frequency range. The spectral density, Φ(ω) of either the noise or the signal is the Fourier transform of that component squared. This is a representation of the physical energy contained within the component. So,

$$Φ ( ω ) = {\vert \frac{1}{\sqrt{2 π}} {\int }_{- ∞}^{∞} f ( t ) {e}^{- i wt} d t \vert}^{2} = \frac{F ( ω ) F * ( ω )}{2 π}$$

Where: ω is the angular frequency (2π cycles-per-second)
F(ω) is the Fourier transform of f(t) of signal or noise as appropriate
F*(ω) is the complex component of F(ω)

In the case of design of a communication system for transmission within a flowing fluid column, ‘colored’ noise over a short enough frequency interval can be modeled as Gaussian. So a high pass filter from approximately one Hz (cycle-per-second) (specifically about 1.3 Hz) is sufficient to eliminate much of the low frequency noise within the drilling environment. Any periodic pressure transient with frequencies above this frequency is easily detectable.

One consequence of the above result is that oscillations at frequencies from about 3 cycles-per-second upward can be detected when their pressure rise is on the order of a few to a couple of tens of PSI. This is in contrast to conventional mud pulsers which frequently require near DC pulses of 150 PSI or more to be detected.

Therefore, in my previous U.S. Pat. Nos. 6,867,706 and 7,319,638, I taught methods of modifying the design of positive fluid pulsers that shifted the frequency of the signal away from the region of substantial drilling noise thereby reducing the requirement for the high pressure pulses. In the '706 patent, I also taught a method of generating and varying oscillating pressure signals in the drilling fluid.

While the structure and method shown and described in these patents have been successful, the resulting devices must employ springs that retain sufficient energy to shear a fluid stream against unbalanced fluid pressures. The energy required to shear the fluid stream is variable and dependent on unpredictable pressure drop across the valve. Additionally, the method taught in these previous patents did not address the problem of transmission of signal in flow direction or methods of detecting signals. The system and method disclosed herein address these and other shortcomings

Because the primary action of the poppet and orifice are responding to pressure differences within the conduit, the method of this invention using a sense piston can be rearranged to be either upstream or downstream in a manner as described.

### SUMMARY OF THE INVENTION

The present invention addresses these and other drawbacks in the art by employing a pressure balance drive cylinder exhaust valve driven by a toggling sense piston. Reset of the sense piston creates a balance in pressure across the exhaust valve such that, as the pressure within the drive cylinder regeneratively increases, this pressure is applied to both sides of the exhaust valve. The pressure balance thus created greatly reduces the force necessary to close the exhaust valve. Once the sense piston is driven past the toggle allowing the drive cylinder pressure to have an offset pressure equal to the downstream main valve pressure, the drive cylinder forces the exhaust valve open thus decreasing the drive cylinder pressure. The pressure reduction allows the sense piston to reset, thereby restarting the process. Because the main poppet is driven by the drive cylinder pressure, the cyclic set and reset of the sense piston results in drive cylinder pressures that alternatively insert and remove the poppet from the orifice causing pressure oscillations within the conduit. This operation will continue as long as sufficient fluid flows through the conduit. The frequency of this oscillation is controlled either by the rate that fluid is allowed to enter the drive cylinder or by a sear used to interrupt operation of the sense piston.

The invention teaches a method of creating pressure oscillations and employing either time position modulated, combinatorial encoding, or direct binary encoding to encrypted data using asynchronous frequency shift keying and detecting the resulting signal. This signal is bidirectional, propagating through the communication medium both upstream and downstream from the source so that stationary receivers located upstream and downstream will receive the same signal at different frequencies separated by the Doppler shift resulting from the velocity of the medium.

These and other features of the present invention will be immediately apparent to those skilled in the art from a review of the following description along with the accompanying drawings.

### BRIEF DESCRIPTION OF THE DRAWINGS

FIG. 1 is a sectional view of a typical drilling system in which the present invention finds application.

FIG. 2 is a schematic sectional view of a preferred embodiment of an oscillator valve mounted within a drill collar.

FIGS. 3a, 3b, and 3c are elevational views in partial section of known pulsers with the poppet and orifice in various known configurations.

FIG. 4 is a plot of differential pressure as a function of force for the insertion of a poppet into an orifice.

FIG. 5 is a sectional view of a presently preferred embodiment of an oscillator in accordance with the teachings of the present invention.

FIG. 6 is a plot of the pressure oscillation waveform produced by the transmitter component of the invention.

FIG. 7 is an electronic schematic of a detection method for signals received from the oscillator.

FIG. 8 is a representation of mud pulses using pulse position jitter coding to encrypt data compared to a series of asynchronous oscillations created by the transmitter.

FIG. 9 is a representation of mud pulses using combinatorial encoding to encrypt data compared to a series of asynchronous oscillation created by the transmitter.

FIG. 10 is a representation of mud pulses using binary encoding to encrypt data compared to a series of asynchronous oscillations created by the transmitter.

FIG. 11a is a time plot illustrating a comparison between synchronous Phase Shift Keying and Frequency Shift Keying.

FIG. 11b is a time plot illustrating a comparison between asynchronous Phase Shift Keying and Frequency Shift Keying.

### DETAILED DESCRIPTION OF A PREFERRED EMBODIMENT

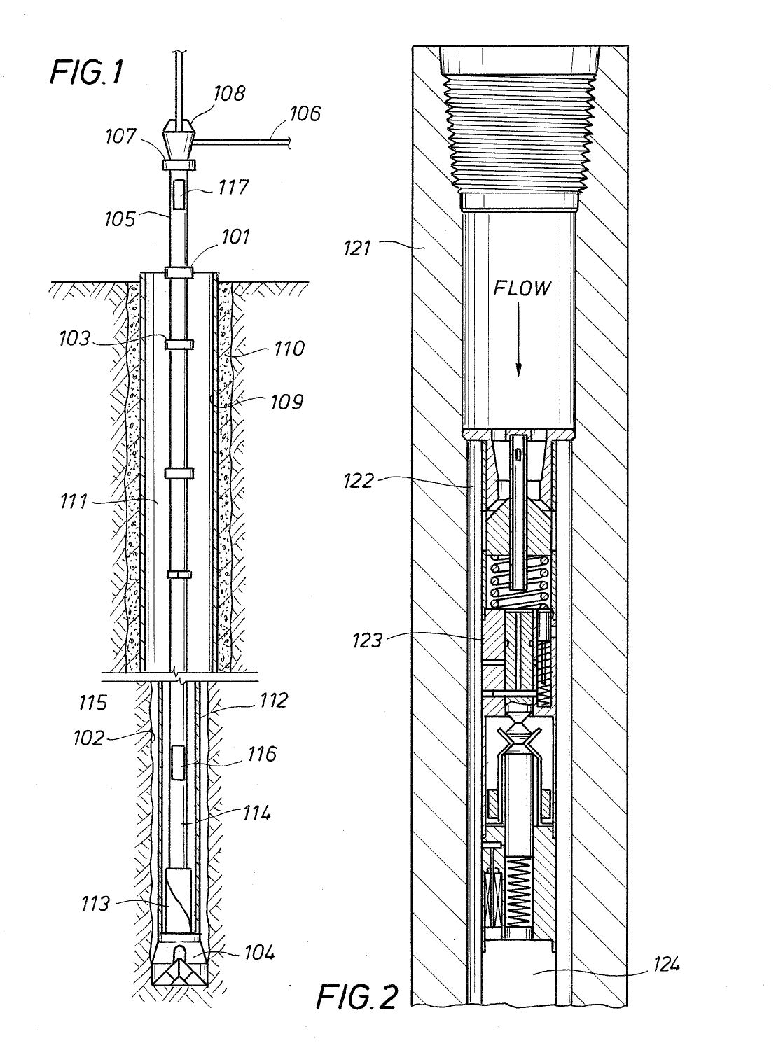

FIG. 1 illustrates a basic rotary drilling system in a bore hole 102 formed by a typical drill bit 104. The drill bit 104 is rotated by a jointed drill pipe 103 which joins a surface drive mechanism such as a Kelley bushing to 101 that is used to turn a Square Kelley 105. In some cases, a top drive system is used to rotate the drill pipe. Drilling fluid (mud) flows from pumps (not shown) through a flow line 106 and through a swivel 107 attached to an elevator 108 that is used to raise and lower the drill assembly and to control the weight on bit. Previously drilled portions of the hole are supported by casing 109 which is used to isolate different strata and bonded to these strata by a layer of cement 110. The annulus 111 extends from the bit 104 to the surface outside of the drill pipe and is used as a conduit to return drilling mud carrying cuttings to the surface.

In other applications, such as for example sewer cleaning operations, a major fraction of the fluid is routed through the conduit ahead of the bit and is not returned via an annulus.

Returning to FIG. 1, attached to the bottom of the drill pipe are a collection of drilling tools referred to as a bottom hole assembly 112. Within and part of the bottom hole assembly 112 may be found a positive displacement motor 113, power supplies and formation sensor arrays 114, direction and attitude sensors 115, transmitter components 116, and other drilling tools and instruments. Conventionally, the transmitter components consist of mud pulsers or mud sirens. The system described herein differs from conventional MWD or LWD systems in that the transmitter components are replaced by the below described oscillator. Also, such a system may have an additional transmitter component 117 located within the drilling fluid conduit above the surface to communicate to downhole components typically found in the bottom hole assembly 112.

FIG. 2 depicts a schematic of the mount of the component within a portion of the bottom hole assembly. An external container comprises a drill collar 121, although similar mounts may be employed within a stabilizer, force subassembly, rotary steerable housing, or other drilling tools employed within a bottom hole assembly. A transmitter 123 and an instrument package 124 are mounted within the external container 121. This assemblage is suspended with the drill collar 121 in such a way that an annulus 122 is created inside the drill collar. This annulus continues past lower sections of the assemblage where the annular flow is recombined. For surface implementation such as that illustrated in FIG. 1, the transmitter component 117 may be mounted in a similar fashion. However, it may be preferred to supply a control signal via feedthrough from outside the flow line, kelley, or whatever conduit is used as a mount.

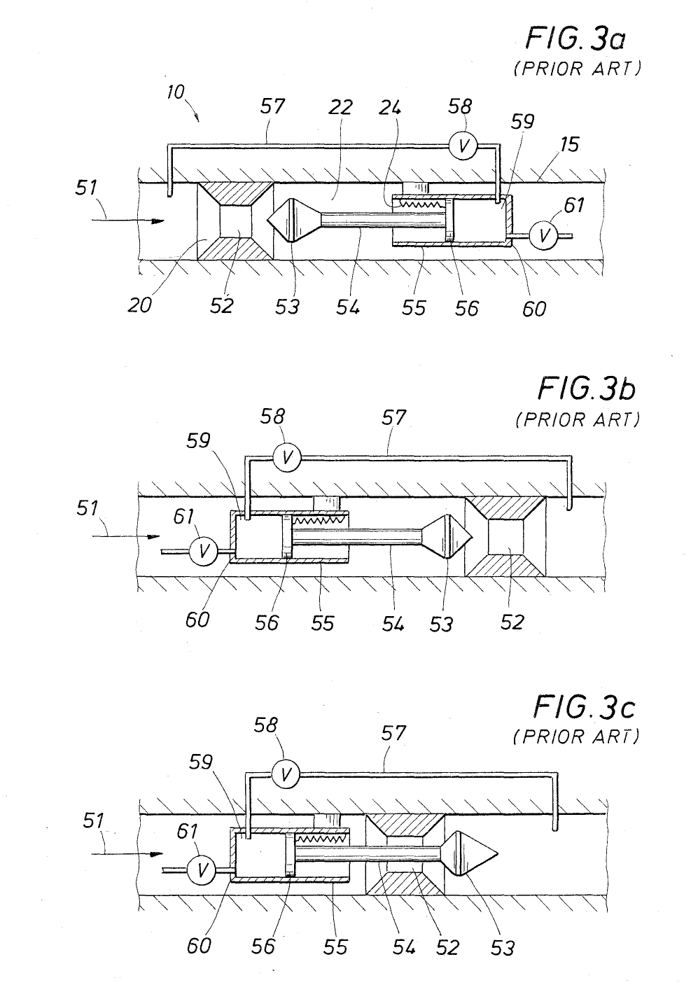

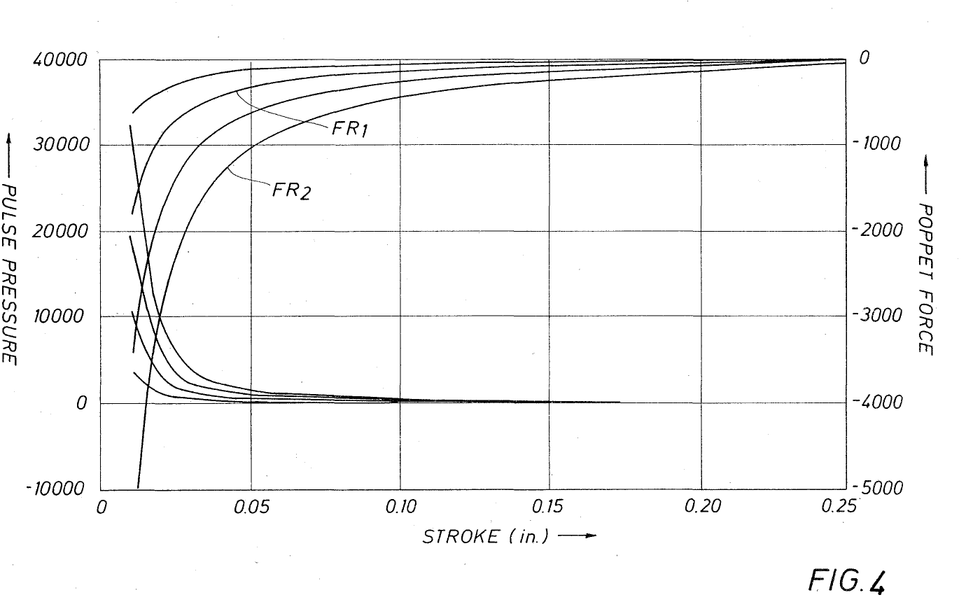

FIGS. 3a, 3b and 3c depict configurations of a known positive pulser, and like structural components are provided with like element numbers. The new device which is the subject matter of the present invention eliminates need of a pilot valve 58. However, as with the illustrated pulsers multiple layouts are possible. In FIG. 3b, a poppet 53 is positioned upstream of an orifice 52. One drawback of the configuration of FIG. 3b is that fluid flow as shown exerts a closing force on the poppet against the orifice, a force which must be overcome in returning the poppet to the retracted position. This drawback is overcome by the configuration of FIG. 3c by placing a drive cylinder 59 upstream of the orifice 52 while placing the poppet downstream of the orifice. However, the configuration of FIG. 3c includes the drawback of a rod 54 going through the orifice, and thereby taking up some of the cross sectional area for fluid flow through the tool. It will be understood by those skilled in the art that the present invention may be used effectively without further adaptation with any of the configurations illustrated in FIGS. 3a, 3b, and 3c.

FIG. 4 illustrates typical quaternary relations between the force on the valve poppet, the displacement of the poppet from the orifice, and the resulting pressure drop across this poppet orifice pair as a function same displacement of the poppet and the flow rate. This figure shows the poppet force required to develop a particular pressure is a parametric function of flow rate. The exact shape of these curves is controlled by the rate of momentum change in the fluid traversing the orifice which is controlled by the shape of the poppet and orifice. The illustrated curves, FR1 and FR2 are a subset of an infinite number of such curves for a variety of fixed flow rates. These curves indicate that the require stroke length and the displacement of the poppet from the orifice necessary to achieve this given pressure excursion is a parametric function of flow rate. This is relevant because applications where the invention finds use are typically those with positive displacement pumps as a fluid source. Flow rate, using these types of pump, does not vary with a variation of circuit pressure around the fluid circuit.

As can be readily discerned, for a variety of volumetric flow rates, approximately the same poppet force is require to attain a desired pulse pressure however this force is obtained at different displacements from the orifice. Therefore, the actual positions of the poppet relative to the orifice for pair of both high and low pressure conditions will vary with flow rate. If the poppet force is set by the structure of the invention, then the pressure amplitudes will be nearly constant over a range of flow rates. In the absence of this force, the poppet will be driven away from the orifice. Therefore, by adjusting the force of insertion of the poppet into the orifice a given pressure drop can be obtained somewhat independent of the flow rate.

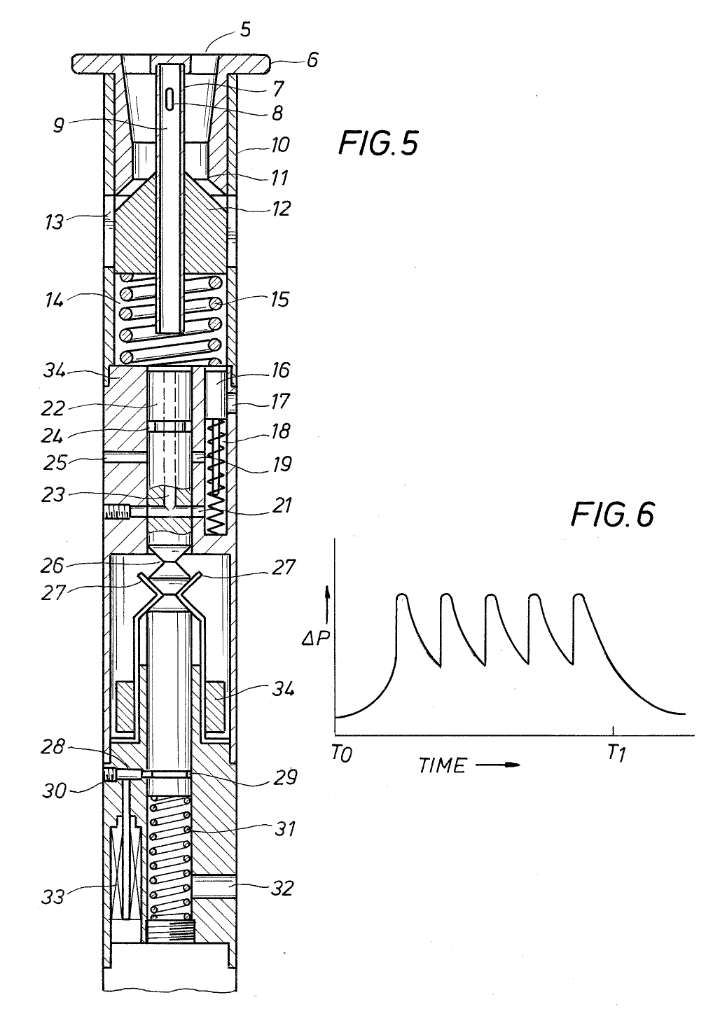

FIG. 5 is a cross section of a transmitter of this invention. As mounted, all fluid flowing in the drill pipe is forced through the device by entering through inlet holes 5 in an orifice flange 6 which is shown with a external upset allowing seating on the inside of the collar 121 shown in FIG. 2. A through tube 7, with an internal gallery 9 extends from a set of inlet ports 8 upstream of an orifice throat 11 to the main drive cylinder 14 below a poppet 12. The main drive cylinder corresponds to the chamber of my earlier U.S. Pat. Nos. 6,867,706 and 7,319,638. A bias is applied by a main poppet spring 15 so the force tending to close the poppet is a function of a combination of the upstream pressure, as described by FIG. 4, acting on the base area of the poppet 12 and the spring bias supplied by the main poppet spring 15. Fluid passing through the orifice throat 11 can exit through a set of ports 13 in the housing. However, due to the pressure imbalance, the poppet 12 is forced ever more tightly toward the orifice throat 11.

A ported sense slide 22 is located within a slide housing 34 which also closes the drive cylinder 14. The lower end of the sense slide is an over-center reciprocating cam 26 acted upon by cantilever springs 27 and maintained against the bias pressure within the drive cylinder 14 by a sense slide spring 31. An exhaust valve element 16 is likewise exposed to pressure within the drive cylinder 14. Opening of the exhaust valve element 16 allows drainage of pressure within the drive cylinder 14 through an exhaust port 17 into the down stream pressure within the annulus 122 (see FIG. 2). The force to move the exhaust valve element 16 and actuate the exhaust port 17 comes from a weak bias spring 18 and pressure delivered through either a drive cylinder pressure port 21 or an annular exhaust pressure port 19. Activation of these two ports is controlled by the ported sense slide 22. The ported sense slide 22 has an internal gallery 23 that extends to a cross drilled port that in the illustrated position connects with the drive cylinder pressure port 21 allowing the exhaust valve element 16 to receive a closing pressure bias from the drive cylinder 14. This forces the exhaust valve element 16 across the exhaust port 17, thereby insuring regenerative operation buildup of drive cylinder pressure. The force on the drive cylinder face of the ported sense slide 22 will rapidly increase, compressing the sense slide spring 31 and forcing the cantilever springs 27 over the cam of the ported sense slide 22. The cantilever springs 27 are retained by a spring retainer 34 which allows adjusting the spring action length. The snap action, aided by the cantilever springs 27 acting on the cam of the ported sense slide 22 thus retracts the ported sense slide 22, separating the pressure connection that is the principal force holding the exhaust valve element 16.

As a result of the retraction, an internal upset 24 on the exterior of the ported sense slide 22 is aligned with the annular exhaust pressure port 19, and with the external exhaust valve bias port 25. This reduces the exhaust valve bias to the downstream pressure within the annulus 122 (see FIG. 2) thus allowing the higher pressure within the drive cylinder to force the exhaust valve element 16 past the exhaust port 17. Provided that the flow rate through the inlet port 8 is below that of the exhaust port 17, the regenerative process will be reversed allowing the momentum of the fluid impinging on the poppet 12 to drive this piston down until a pressure drop approaching the bias of the main poppet spring 15 is achieved and the force of the sense slide spring 31, can return the ported sense slide 22 to the initial position.

Frequency and symmetry of the resulting cyclic operation is largely controlled by the flow rate through the inlet port 8. It is necessary to allow expulsion and insertion of fluid volumes to offset volumes displaced by the ported sense slide 22. This is accomplished with a volume balance port 32 to the annulus 122 (FIG. 2). The simplest frequency shift is between DC and some non-zero frequency. This is accomplished by inserting a sear 28 into a detent 29 on the external face of the ported sense slide 22. In normal operation, a sear spring 30 forces the sear into the detent 29. Extraction of the sear is accomplished by activating a solenoid 33.

It will be understood by those skilled in the art after examining FIG. 3a, FIG. 3b, FIG. 3c and FIG. 4, that the poppet, drive cylinder, and piston arrangement depicted in FIG. 2 and FIG. 5 with plumbing and repositioning of the valves could as well be positioned upstream of the orifice throat 11.

The configuration shown and described corresponds to FIG. 3a, this configuration has several advantages over the devices of FIGS. 3b and 3c. This device configuration can be less expensively manufactured than the other configurations and because the direction of drive opposes the flow, the principal failure modes result in opening of the orifice allowing full flow through the devices. When drilling wells this results in safer failure modes allowing fluid volumes to be injected after a failure to offset well pressure.

When configured as described within a conduit carrying flowing fluid and the sense piston not impeded in operation by a sear, the device will create a pressure oscillation within the conduit.

FIG. 6 is a representation of the pressure waveform produced by activation of the invention. Frequency of this wave form is primary a function of the volumetric throughput of the flow diverted through the drive cylinder 14 of FIG. 5. Therefore frequency is a function primarily of the size of the inlet port 8 of FIG. 5. The symmetry of this wave form is dependent on the ratio of the relative rates of charge and discharge of the drive cylinder 14 of FIG. 5. Subject to the requirement that the flow rate into this chamber through inlet port 8 FIG. 5 be below the rate that can be drained by the opened exhaust valve 16 of FIG. 5, the larger the ratio of inlet port to the exhaust valve area the more symmetric the waveform.

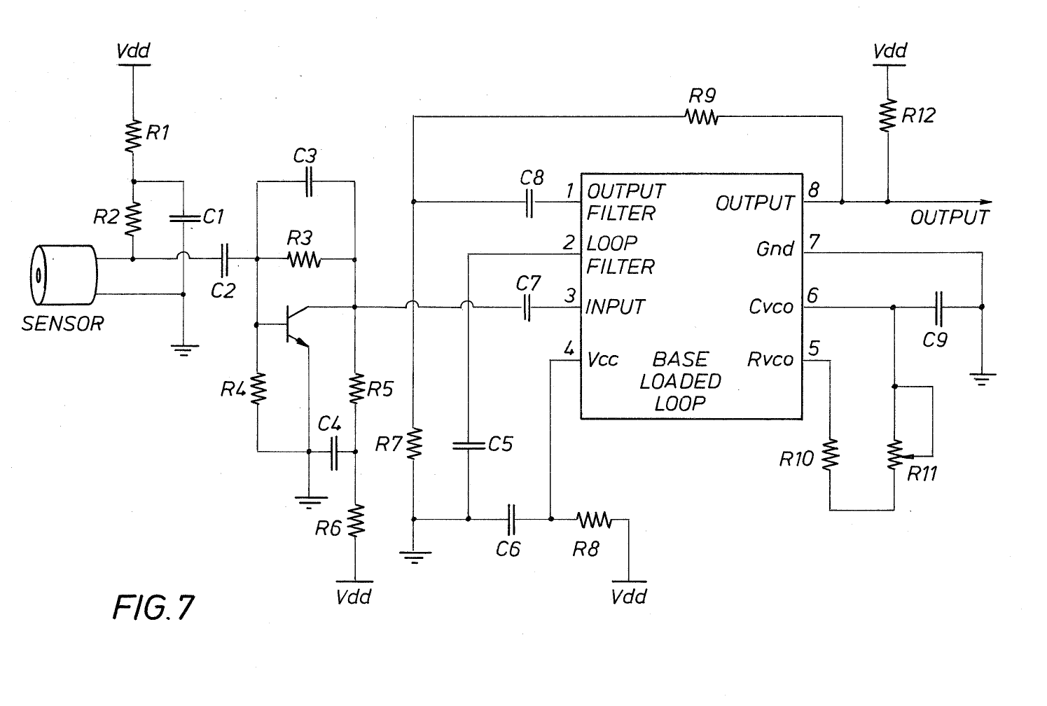

FIG. 7 is a schematic representation of a general detector circuit suitable for discerning presence of the oscillations within the conduit and built with commonly available components. By component adjustment the tuner can be tuned so as to be sensitive to frequencies from 0.1 Hz to 0.5 GHz. Fine frequency adjustment can be accomplished using R11 which controls bias on the voltage controlled oscillator portion of the phase locked loop. Because the information conveyed is encrypted as variation in frequency, an absolute pressure sensor as is typically employed in these applications is unnecessary and the sensor may reside in a pressure balanced environment. Additionally, various sensor types such as piezoelectric ceramics, capacitive sensors, magnetostrictive inductive devices, mechanical oscillators, strain gauges working on various materials, flexible pressure elements with interferometer displacement measurement, and flat coil pickups can be used.

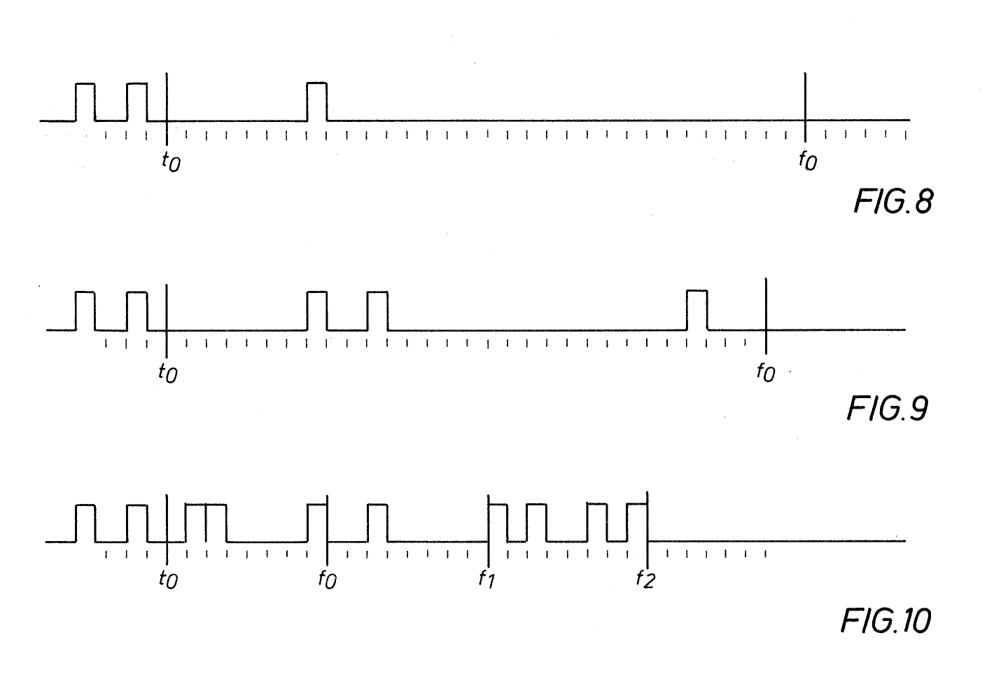

FIG. 8 is a representation of the method of simple pulse position modulation, a well known asynchronous method of data encryption. This method has been employed extensively in commercial applications of MWD transmitters. A time reference t₀ is generally established by transmitting a pair of pulses that do not correspond to a uniform time spacing employed in the transmission of the information. The value of transmitted information is represented by temporal displacement of data pulses relative to the time reference within a frame ending at f₀. As presented, a total of 16 separate states can be represented by this frame.

FIG. 9 is a representation of combinatorial data encoding using pulse position modulation, also a well know asynchronous method of data encryption. Use of this method for MWD pulses was quantified and described by Rorden in U.S. Pat. Nos. 4,908,804 and 5,067,114. Because early methods of MWD were severely power limited and the major power consumer was solenoids used to shear a flowing stream and create the pulse, improvement of data transmission energy efficiency was a major objective. Combinatorial data encoding provides a greater capacity to present states within a single frame with fewer pulses than Simple Pulse Position Modulation. The total number of states is related by C(N,M)=N!/(M!(N−M)!) or for the M=3 and N=30 as illustrated 4060 states. A combination of M=10 and N=30 can deliver 30,045,015 states. Additionally, noise immunity in combinatorial coding can be improved by using a half Hamming distance between each pulse.

FIG. 10 is a representation of direct binary encoding of information representing three frames of data. Each frame is 8 units in length and can represent 256 separate states. A total of 16,777,215 states can be represented by these frames. However, use of this method of data encryption may require creation of 24 pulses after synchronization to deliver information.

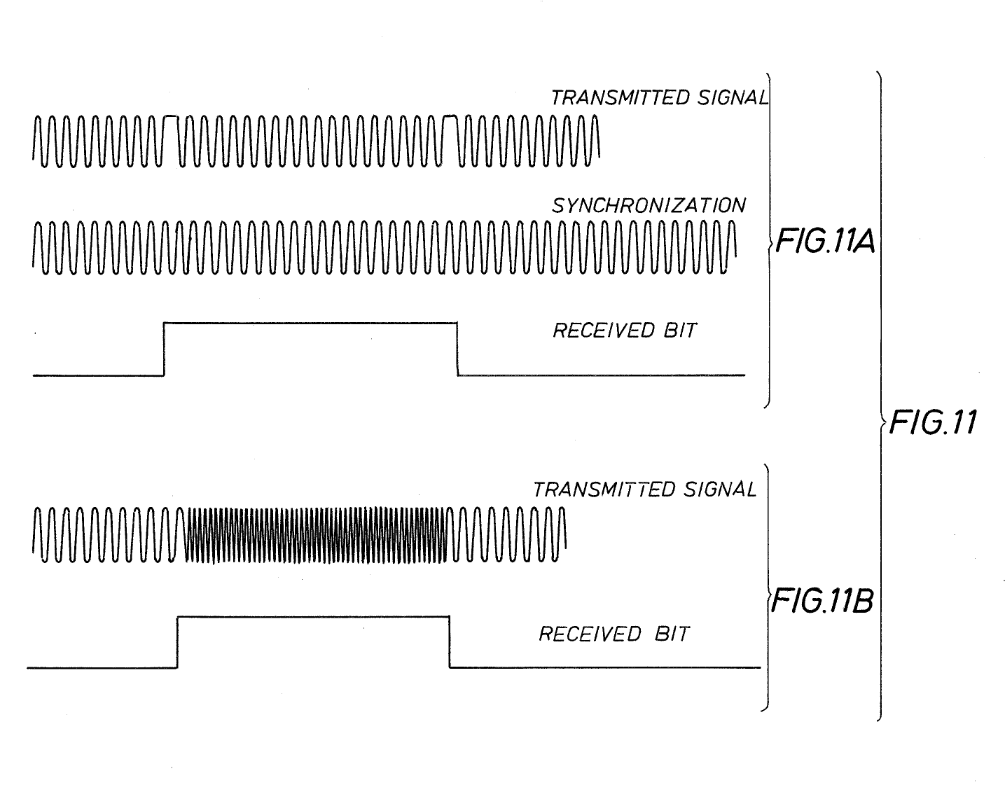

FIGS. 11a and 11b illustrate a comparison of a bit that may be part of encoded data being transmitted by Synchronous Phase Shift Keying as employed by current users of MWD/LWD systems employing rotary valves FIG. 11a, with a bit transmitted by Frequency Shirt Keying per this invention FIG. 11b. The transmission indicated by the first graph of FIG. 11a, contains a fixed frequency that only creates transient sideband harmonics when the rotary valve is momentarily stopped/slowed to shift the phase. This phase shift is noted compared to a fixed frequency reference, the second graph of FIG. 11a, generally designed into the transmitter and known to the detecting apparatus. Because transmission characteristics change resulting in minor frequency shifts, numerous disclosures exist to allow frequency tracking of the signal to maintain this synchronization. The resultant bit is shown on the third graph of FIG. 11a. This recovered bit is part of the encrypted data. The transmitted signal containing encrypted Asynchronous Frequency Shift Keying as disclosed herein does not require a nearly constant frequency reference. Instead the only requirements are that the two composing frequencies be sufficiently separated to allow detection and the bit be sufficiently wide to allow the frequency character to be transmitted.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A transmitting element for transmitting encoded data asynchronously within a fluid filled conduit employing frequency shift keying within the conduit, the conduit defining a first, lower pressure region and a second, higher pressure region, the transmitting element comprising:
a. a hydraulic oscillator comprising
i. a chamber;
ii. a driver piston in the chamber within a drive cylinder;
iii. a poppet coupled to and driven by the driver piston; and
iv. an orifice adjacent the poppet; and
b. a pressure balanced exhaust valve between the drive cylinder and an outlet port connected to the first, lower pressure region within the conduit, the pressure balanced exhaust valve comprising:
i. a sense element sensing the pressure within the chamber; and
ii. a toggle mechanism determining a first position for pressure balancing the exhaust valve at a lower pressure within the chamber and a second position pressure balancing the exhaust valve at a higher pressure within the chamber.

2. A method of transmitting encoded data asynchronously within a fluid filled conduit employing frequency shift keying within the conduit, the method comprising the steps of:
a. developing at least two discrete frequencies with an oscillator capable of producing oscillations in fluid pressure in a flowing fluid within the conduit and further capable of delivering two discrete oscillations at frequencies from 0 Hz to 250 Hz; and
b. detecting the oscillations with a detecting element adapted to detect the oscillations from the oscillator.

3. The method of claim 2, wherein the detecting element includes a sensor selected from the group consisting of piezoelectric ceramics, capacitive sensors, magnetostrictive inductive devices, mechanical oscillators, strain gauges working on a predetermined sensitive material, flexible pressure elements, interferometer displacement measurement elements, flat coil pickups, and linear variable displacement transducers.

4. A transmitting element for transmitting encoded data asynchronously within a fluid filled conduit employing frequency shift keying within the conduit, the conduit defining a first, lower pressure region and a second, higher pressure region, the transmitting element comprising:
a. a hydraulic oscillator comprising
i. a main drive cylinder;
ii. a main poppet spring within the main drive cylinder, the spring having a first end and a second end;
iii. a poppet in abutting contact with the first end of the main poppet spring;
iv. an orifice adjacent the poppet and in fluid communication with the fluid in the conduit; and
v. an axially oriented spring retainer in abutting contact with the second end of the main poppet spring; and
b. a pressure balanced exhaust valve comprising
i. a ported sense slide arranged coaxially with the spring retainer, the ported sense slide having a first end and a second end, the ported sense slide further positioned to sense the pressure within the main drive cylinder;
ii. a sense slide spring in abutting contact with the second end of the ported sense slide; and
iii. a spring loaded exhaust valve element including a fluid path between the main drive cylinder and the fluid filled conduit.

5. The element of claim 4, further comprising an orifice flange positioned in proximity to the poppet to define an orifice throat.

6. The element of claim 5, further comprising a first set of ports in fluid communication with the orifice throat to apply fluid pressure of the fluid filled conduit to the poppet against biasing of the main poppet spring.

7. The element of claim 4, wherein the ported sense slide further comprises:
a. an internal gallery coaxial with the sense slide;
b. a drive cylinder pressure port extending radially from the internal gallery; and
c. an internal upset encircling the ported sense slide.

8. The element of claim 7, further comprising an external exhaust valve bias port extending from the ported sense slide and the fluid filled conduit.

9. The element of claim 4, further comprising:
a. a cam defined on the ported sense slide; and
b. a set of cantilever springs in controlling position on the cam.

10. The element of claim 9, further comprising a spring retainer in operative relation with the set of cantilever springs, allowing adjustment of the spring action length of the set of cantilever springs.

11. The element of claim 4, further comprising:
a. a detent on the ported sense slide;
b. a sear arranged for insertion into the detect; and
c. means for extracting the sear from the detent.
